(19) United States
(12) Patent Application Publication
(10) Pub. No.: US 2008/0046260 A1
(43) Pub. Date: Feb. 21, 2008

(54) Automated litigation discovery method and system

(76) Inventors: Jeffrey Brian Ghielmetti, Scotts Valley, CA (US); Cynthia Lynn Ghielmetti, Scotts Valley, CA (US); Daniel M. Fischler, Santa Cruz, CA (US); Mark E. Michels, Campbell, CA (US); Mark Adam Buxbaum, Santa Cruz, CA (US)

Correspondence Address: MARGER JOHNSON & MCCOLLOM, P.C., 210 SW MORRISON STREET, SUITE 400, PORTLAND, OR, 97204, US

(21) Appl. No.: 11/501,151

(22) Filed: Aug. 7, 2006

(51) Int. Cl. G06Q 10/00; G06Q 30/00

(52) U.S. Cl. 705/1

(57) ABSTRACT

An automated litigation discovery method and system are described. Data having a number of files is electronically gathered from different sources. The gathered data is automatically processed using a processor. The processor identifies software application files and compares the software application files to a database having a number of pre-existing files. If the software application file matches a pre-existing file in the database, then the software application file is removed. Also, the processor identifies and marks the duplicate files. The processed data is transmitted to a reviewer. The reviewer reviews the processed data.

### TECHNICAL FIELD

Embodiments of the present invention pertain to an automated litigation discovery method.

### BACKGROUND

In law, litigation discovery is the pre-trial phase in a lawsuit in which each party can request and/or compel the production of documents and other evidence from other parties. Often, litigation discovery is a process that includes manually gathering data from different sources. For large corporations, the litigation discovery process frequently involves gathering data from a multitude of sources such as databases, individual custodians, web sources, tape backups, hardcopy documents, document repositories, emails, and/or other relevant sources. In addition, not only does the litigation discovery process for large corporations involve accessing a large number of sources, each of the accessed sources often yield a high volume of possibly relevant data as well.

Moreover, the data gathered (e.g., from an individual custodian) is often unorganized, which makes it difficult for a reviewer to efficiently analyze the data. Furthermore, the data gathered frequently contain standard software application files and/or duplicate files, which are not needed for data analysis, but cause the file sizes to be larger than needed and add to the overall data size. Furthermore, the litigation data gathering process can also disrupt an employee's work schedule and negatively impact corporate productivity.

Consequently, the litigation discovery process for large corporations is often exceedingly time-consuming because it involves manually gathering, processing, and publishing a daunting amount of data. As a result, litigation discovery processes can be highly costly.

### BRIEF DESCRIPTION OF THE DRAWINGS

FIGS. 1A, 1B, 1C, 1D, and 1E illustrate block diagrams of an automated litigation discovery system in operation upon which embodiments can be implemented.

FIG. 2 illustrates block diagrams of a processor identifying and removing software application files upon which embodiments can be implemented.

FIG. 3 illustrates block diagrams of a processor identifying and marking a duplicate file upon which embodiments can be implemented.

FIG. 4 illustrates block diagrams of a reviewed data upon which embodiments can be implemented.

FIG. 5 illustrates block diagrams of a processor assigning a tag to a file upon which embodiments can be implemented.

FIG. 6 illustrates a flowchart of an automated litigation discovery method upon which embodiments can be implemented.

FIG. 7 illustrates a flowchart of an automated evidence management method upon which embodiments can be implemented.

FIG. 8 is a block diagram that illustrates a computer system upon which embodiments of the may be implemented.

### DETAILED DESCRIPTION OF THE DRAWINGS

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which can be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention can be practiced without these specific details. In other instances, well known methods, procedures, components, and circuits have not been described in detail as not to unnecessarily obscure aspects of the invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. A procedure, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, bytes, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “setting,” “storing,” “scanning,” “receiving,” “sending,” “disregarding,” “entering,” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

Traditionally, the litigation discovery process for large corporations often involves manually gathering and processing large amounts of data from a multitude of sources. Consequently, the litigation discovery process for large corporations is frequently extremely time-consuming and costly.

For example, the litigation discovery process requires data gatherers to spend long hours gathering, analyzing, and organizing data. Also, frequently, a significant number of corporate employees have to participate in the process as well to transfer individual data over to the data gatherers. Hence, disadvantageously, not only does the litigation discovery process negatively impacts employee productivity, it also requires corporate resources to be expended on data gatherers.

In contrast to traditional approaches, embodiments automatically collect and process data. In one exemplary embodiment, the method includes electronically collecting data having a number of files from different sources. Further, the method includes automatically processing the data using a processor. The processor identifies software application files and compares the software application files to a database having a number of pre-existing files. If the software application file matches a pre-existing file in the database, then the software application file is removed. Also, the processor identifies and marks the duplicate files. In addition, the method includes transmitting the processed data to a reviewer. The reviewer reviews the processed data. Moreover, reviewed data is received from the reviewer and displayed (e.g., displaying responsive data).

In one example, data is electronically collected from databases, web sites, tape backups, hard copy documents, individual employee data, email exchange archives, and document repositories.

The collected data is processed using a processor. In the present example, the processor identifies standard software application files and compares it to a database (e.g., the National Institute of Standards and Technology database and/or a database of common system files and catalogs). If the processor determines that a standard software application file matches a pre-existing file in the database, then the processor proceeds to remove the standard software application file. Also, the processor identifies and marks duplicate files to reduce the cost of review.

Subsequently, in one example, the processed data is transmitted to a reviewer (e.g., an attorney). The attorney reviews the process data. In one instance, the attorney marks the processed data (e.g., classify the data as responsive, non-responsive, privileged, and/or hot). The reviewed data is then displayed to a reviewer.

Hence, embodiments allow an automatic and proficient collection of electronic data. Moreover, embodiments are capable of processing the collected electronic data effectively. Advantageous, embodiments can make the litigation discovery process more efficient and less costly.

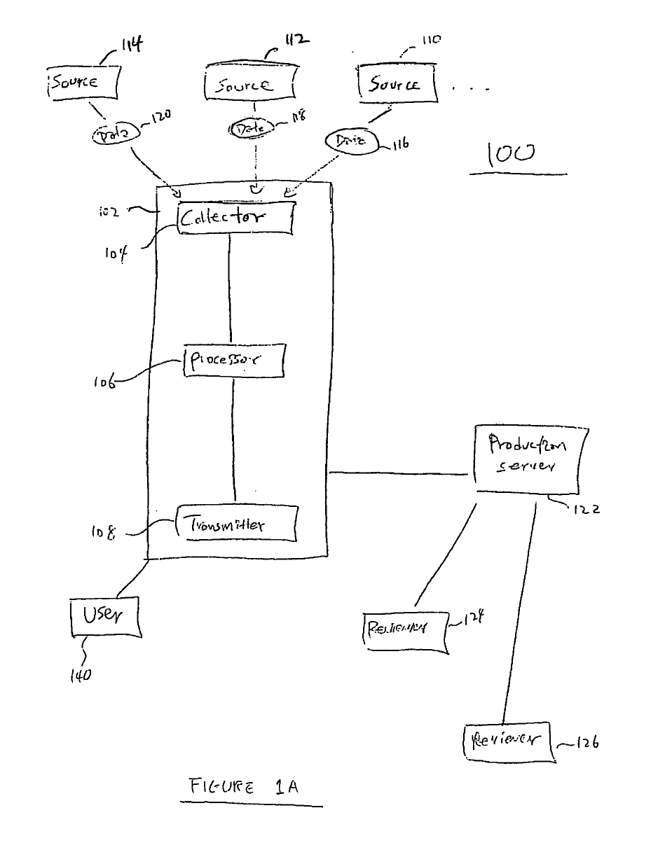

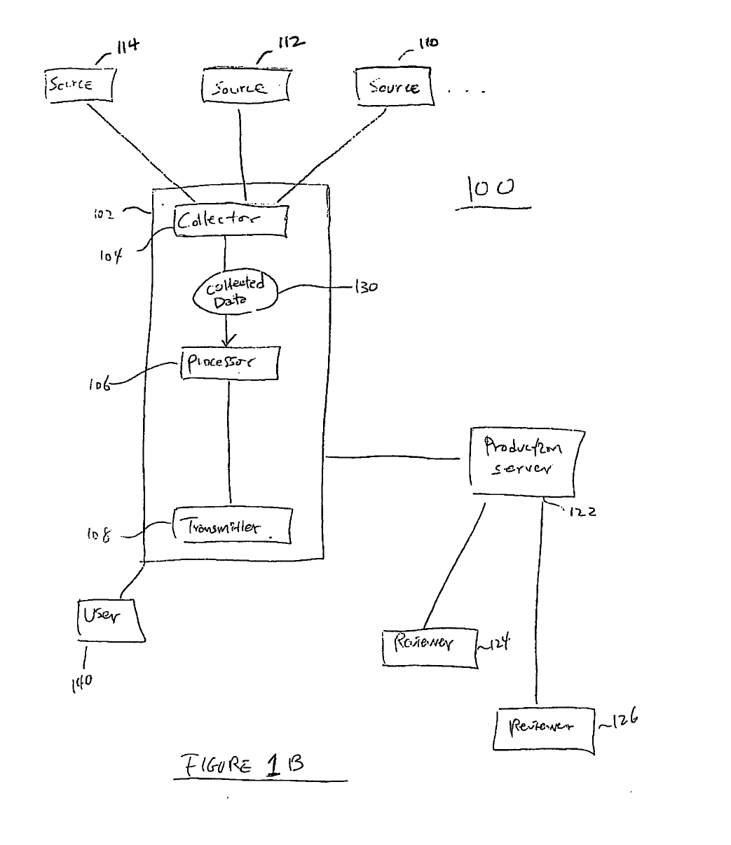

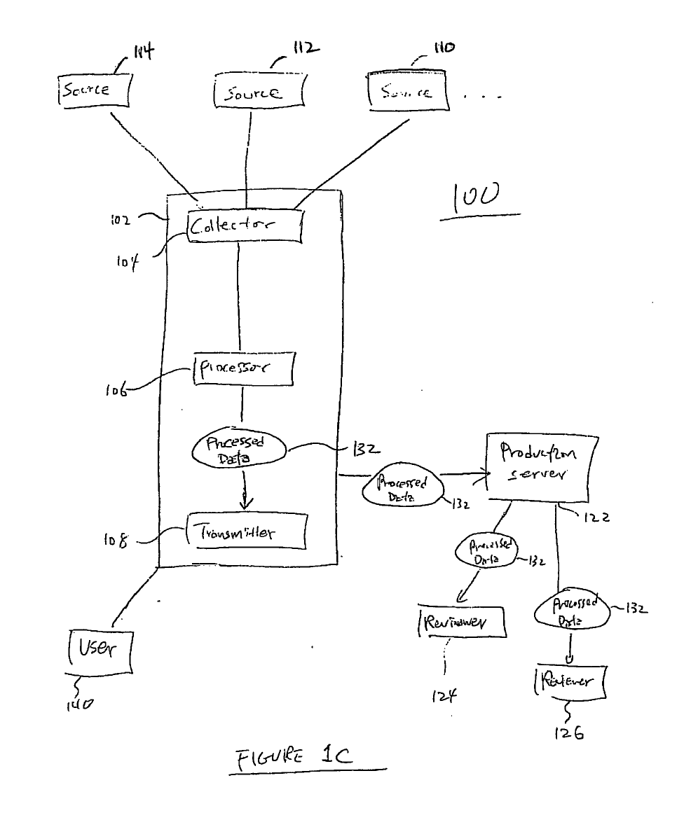

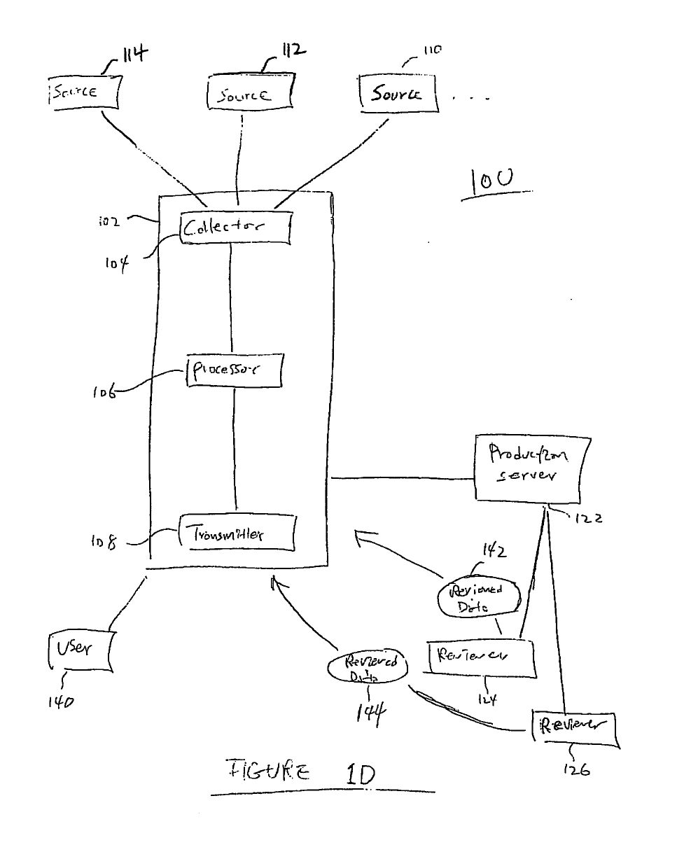

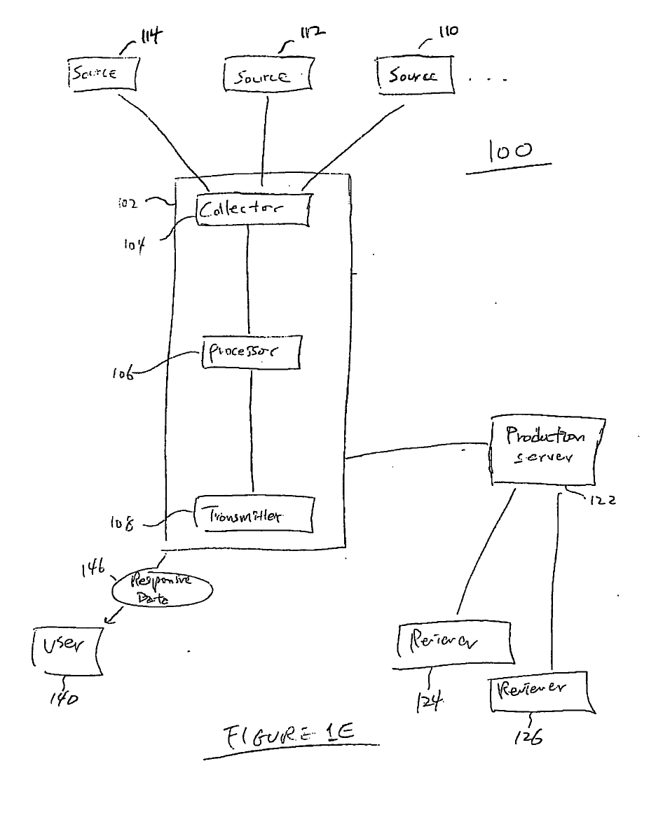

FIGS. 1A, 1B, 1C, 1D, and 1E illustrate block diagrams of an automated litigation discovery system 100 in operation upon which embodiments can be implemented.

With reference to FIG. 1A, automated litigation discovery system 100 includes source 114 (e.g., a database), source 112 (e.g., an email archive), and source 110 (e.g., an individual custodian). The three sources, source 110, source 112, and source 114 are coupled with data management system 102, which includes collector 104 for collecting data, processor 106 for processing data, and transmitter 108 for transmitting data. The automated litigation discovery system 100 also includes reviewer 140 (e.g., an attorney), production server 122 for forwarding information to reviewers, and reviewers 124 and 126 for reviewing data (e.g., processed data).

Although automated litigation discovery system 100 is shown and described as having certain numbers and types of elements, the embodiments are not necessarily limited to the exemplary implementation. That is, automated litigation discovery system 100 can include elements other than those shown, and can include more than one of the elements that are shown. For example, automated litigation discovery system 100 can include a greater or fewer number of sources than the three sources (source 110, source 112, and source 114) shown. Similarly, in another example, automated litigation discovery system 100 can include a greater or fewer number of reviewers than the two reviewers (reviewer 124 and reviewer 126) shown.

In FIG. 1A, in one embodiment, collector 104 collects data 116, data 118, and data 120 from source 110 (e.g., websites), source 112 (e.g., tape backups), and source 114 (e.g., document repositories) respectively. Data can be collected from a variety of sources.

In one embodiment, data (e.g., structured data) can be collected from databases such as, but not limited to, enterprise resource planning systems, manufacturing systems, and/or other types of enterprise specific databases and/or non-enterprise specific databases. Also, in one example, corporate standard reporting tools can be utilized to extract litigation-specific data (e.g., sales, revenue, customer data, and manufacturer data) for case valuation and economic analysis.

In one embodiment, data (e.g., unstructured data) can be collected from web sources such as, but not limited to, internal and external websites. In one example, a web crawler is utilized to walk through a web site and automatically download keyword hits for review.

In one embodiment, data (e.g., archived data stored offsite and acquired archived data) can be collected and/or restored from tape backups (e.g., 8 mm tapes, 4 mm tapes, and DLT data cartridges).

In another embodiment, data (e.g., hardcopy documents) can be collected by scanning paper and converting it into a reviewer specified format, for example, the Portable Document Format (PDF) format. Also, in one embodiment, the reviewer specified format is a searchable format.

In one embodiment, data (e.g., individual custodian data) can be collected from individuals. In one example, the data can be automatically collected from the individual's email and/or personal documents. In another example, applications programs are utilized to collect data located on a network. In one example, individual employee data is collected from standard backup systems. Moreover, in another example, a full forensic image is accessed to acquire individual employee data. Furthermore, in still another embodiment, data can be collected from an archive (e.g., corporate email).

In yet another embodiment, data can be collected from various types of document repositories. For example, data can be collected from an engineering data management system, an enterprise-specific contracts repository, an enterprise specific NDA repository, and/or an enterprise specific financial documents repository. For example, documents repositories used by the legal department, the manufacturing department, and the engineering department are accessed. Moreover, in one embodiment, a data mining tool is utilized to collect data from the document repositories.

With reference now to FIG. 1B, the different data from sources 110, 112, and 114, such as data 116, data 118, and data 120 collected by collector 104, in one embodiment, are collectively referred to as collected data 130. Collected data 130 is forwarded to processor 106, which processes the data.

Processor 106 is capable of processing the data in different ways. In one embodiment, processor 106 is capable of extracting email messages and converting each email message into a unique file with its corresponding attachment. In one example, email files, Tape Archive (tar) files, and zip files are uncompressed and re-associated with its corresponding attachments. Further, the uncompressed files are stored in the working directory.

In one embodiment, processor 106 is capable of identifying and removing standard software application files (e.g., common system files and catalogs). In one instance, identification and removal of standard software application files is implemented by utilizing a comparison tool that compares all files to a database (e.g., National Institute of Standards and Technology database and/or Cisco database.) to identify and remove standard software application files.

In one embodiment, processor 106 is capable of identifying duplicates. In one example, duplicate files are identified and pre-marked to reduce the cost of review. A file mark can be automatically applied to duplicate files.

In another embodiment, processor 106 is capable of cataloging, indexing, and analyzing collected files to render the documents searchable. In one example, metadata related to the data, such as but not limited to, dates, file size, file type, are cataloged, indexed, and analyzed.

In still another embodiment, processor 106 is capable of assigning a unique tag (e.g., a numerical tag) to files in the database. In one exemplary embodiment, a unique document ID is assigned electronically to documents. The addition of the unique document ID renders it simple to refer to and/or review a document.

With reference to FIG. 1C, in one embodiment, once processor 106 has processed collected data 130, it forwards the processed data 132 to transmitter 108. The transmitter 108 forwards the processed data 132 to production server 122, which in turn forwards processed data 132 to reviewer 124 and reviewer 126.

In one embodiment, the processed data 132 is reviewed by reviewers 124 and 126 (e.g., outside counsels) via an online interface. Also, in one implementation, a processed data 132 can be marked as responsive, non-responsive, privileged, or hot by reviewers 124 and 126. In addition, in one example, reviewer 124 and reviewer 126's information, such as reviewer 124 and 126's activities, reviewer 124 and 126's identities, project status, project notes, and the reviewer 124 and 126's markings of processed data 132 are stored in a database.

With reference to FIG. 1D, once processed data is reviewed by a reviewer, the reviewed data is forwarded to data management system 102. In one example, reviewer 124 and reviewer 126 (e.g., outside counsels) forward reviewed data 142 and reviewed data 144 to data management system 102 respectively. Reviewed data 142 and 144 can be marked as responsive, non-responsive, privileged, and/or hot.

With reference to FIG. 1E, in one embodiment, data management system 102 forwards responsive data 146 to reviewer 140 (e.g., an attorney).

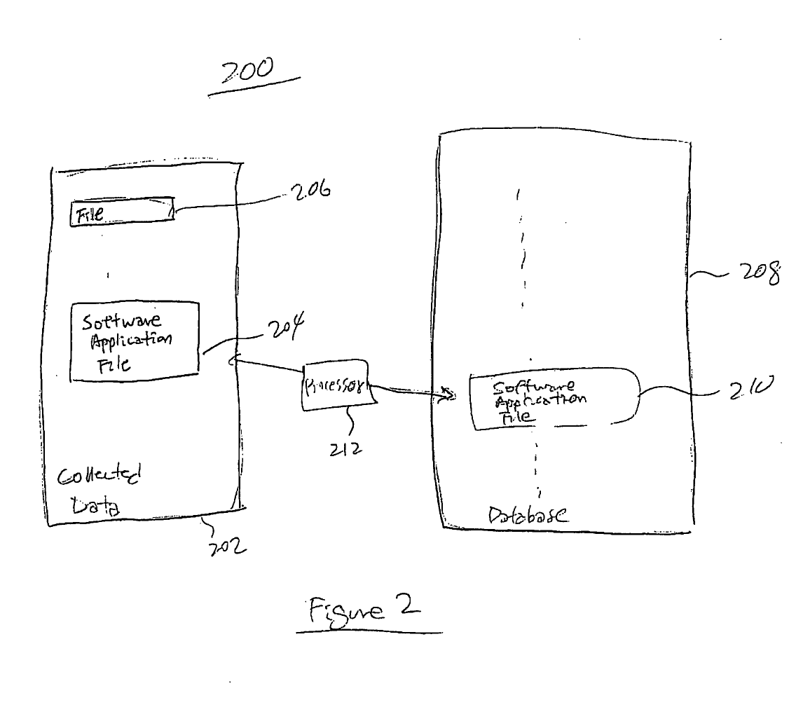

FIG. 2 illustrates block diagrams of a processor 212 identifying and removing software application files (e.g., standard system files) upon which embodiments can be implemented.

FIG. 2 includes processor 212 for processing data, collected data 202, file 206, software application file 204, database 208 for storing files, and software application file 210.

Though FIG. 2 is shown and described as having certain numbers and types of elements, the embodiments are not necessarily limited to the exemplary implementation. That is, for example, collected data 202 can include elements other than those shown, and can include more than one of the elements that are shown. For example, collected data 202 can include a greater or fewer number of files than the two files (file 206 and software application file 204) shown.

In one embodiment, processor 212 identifies software application files included in collected data 202 and compares the identified software application files to database 208 (e.g., a National Institute of Standards and Technology and/or a Cisco database of common system files and catalogs). Database 208 includes a plurality of files, such as but not limited to software application file 210. In one embodiment, the processor 212 determines that software application file 204 matches software application file 210 (e.g., identical content) and removes software application file 204.

Embodiments allow files that may be unnecessary, such as but not limited to standard system files, to be automatically identified and removed. Hence, embodiments can improve the overall efficiency of a litigation discovery system.

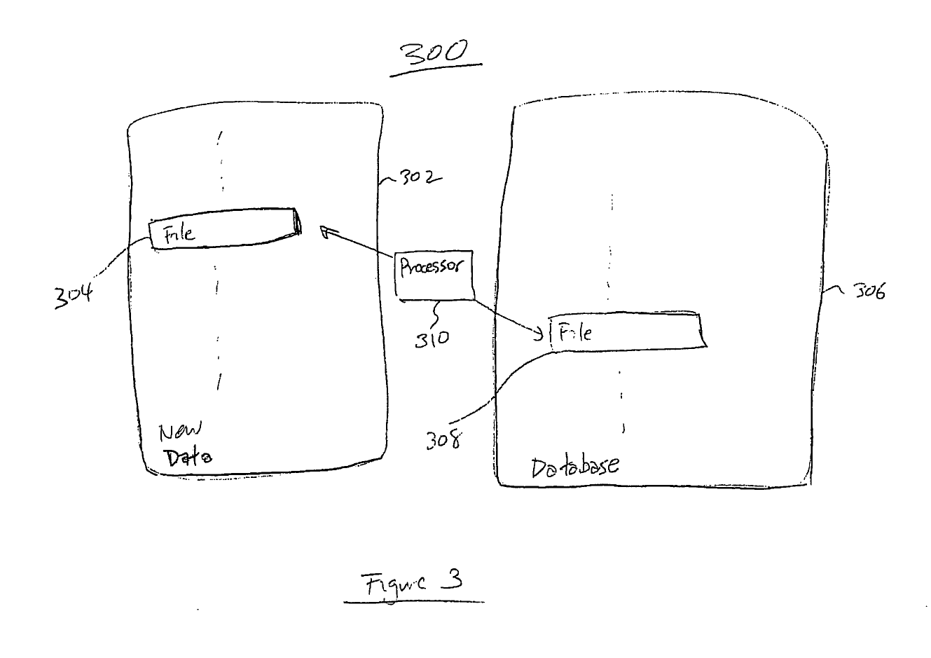

FIG. 3 illustrates block diagrams of a processor 310 identifying and marking a duplicate file upon which embodiments can be implemented.

FIG. 3 includes new data 302 for storing new data, file 304, processor 310 for identifying and marking duplicate files, database 306 for storing files, and file 308.

In one embodiment, processor 310 identifies file 304 and file 308 stored in new data 302 and database 306. In one example, processor 310 determines that file 304 and file 308 are identical and automatically marks file 304 as a duplicate file. The marking of file 304 can be implemented in different ways. For example, file 304 can be flagged, highlighted, and/or labeled.

Embodiments enable duplicate files to be automatically identified and marked, which can help the efficiency of a reviewer (e.g., outside counsel) in reviewing the documents. Advantageously, embodiments allow reviewers the option of skipping duplicate files that has already been reviewed and move more quickly through documents.

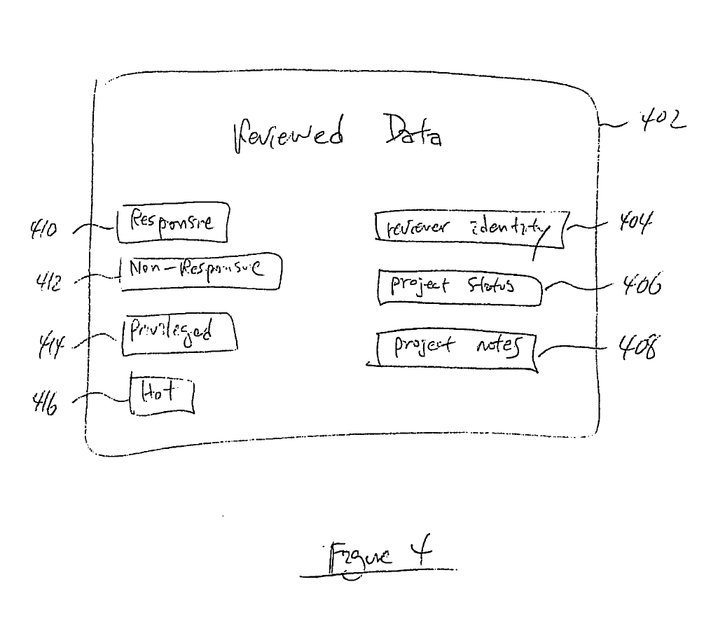

FIG. 4 illustrates block diagrams of a reviewed data upon which embodiments can be implemented. Reviewed data 402 can include different information supplied by a reviewer (e.g., outside counsel). In one example, a reviewer that received processed data from a production server determines whether the processed data is relevant (e.g., responsive, non-responsive, privileged, and/or hot). Also, a reviewer provides information on the reviewer, project status, and/or project notes.

Accordingly, in one embodiment, reviewed data 402 includes responsive 410, non-responsive 412, privileged 414, hot 416, reviewer 404, project status 406, and project notes 408. Further, while reviewed data 402 is shown and described as having certain numbers and types of elements, the embodiments are not necessarily limited to the exemplary implementation. That is, for example, reviewed data 402 can include elements other than those shown, and can include more than one of the elements that are shown. For example, reviewed data 202 can include other information regarding the reviewer and/or the reviewed data.

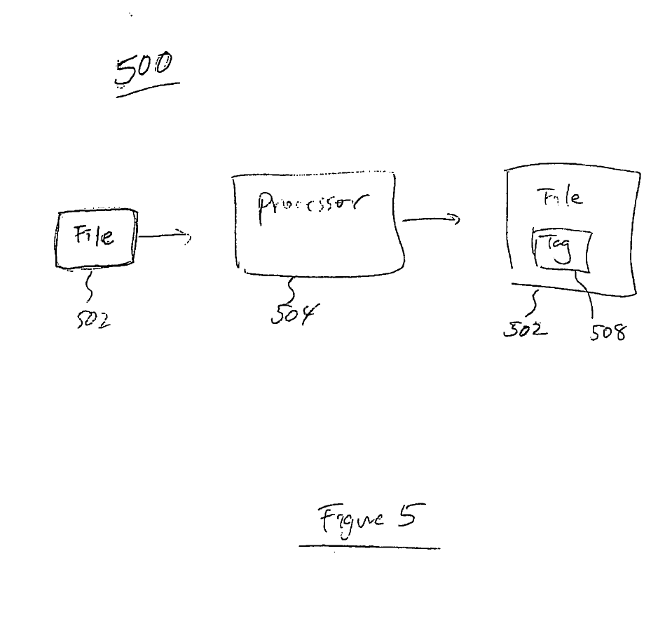

FIG. 5 illustrates block diagrams of a processor 504 assigning a tag 508 to a file 502 upon which embodiments can be implemented. FIG. 5 includes file 502, processor 504, and tag 508.

Processor 504 processes and inserts tag 508 to file 502. In one embodiment, tag 508 is a unique numerical tag (e.g., unique document ID).

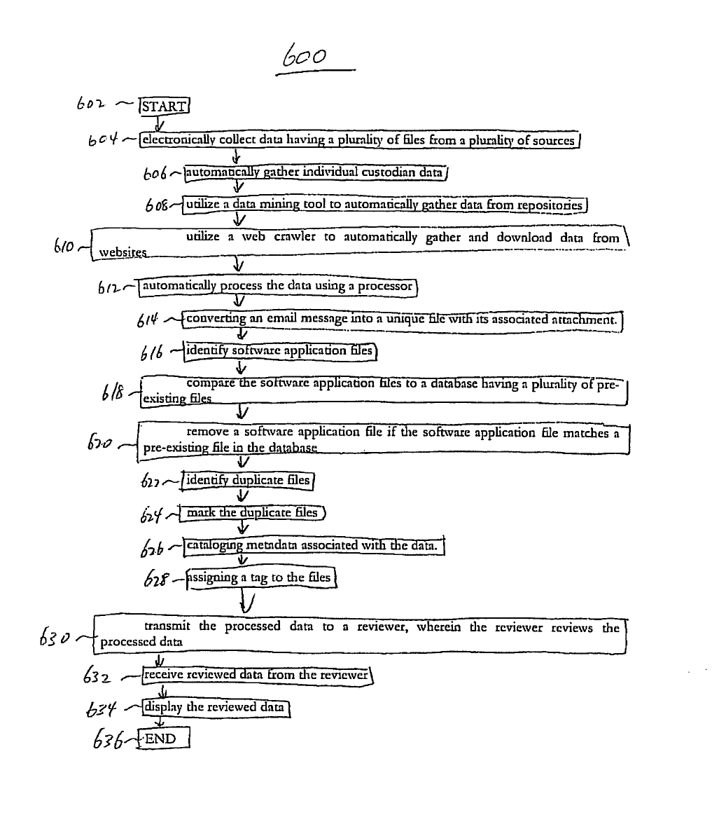

FIG. 6 illustrates a flowchart 600 of an automated litigation discovery method upon which embodiments can be implemented. Although specific steps are disclosed in flowchart 600, such steps are exemplary. That is, embodiments are well suited to performing various other or additional steps or variations of the steps recited in flowchart 600. It is appreciated that the steps in flowchart 600 can be performed in an order different than presented.

At block 602, the process starts.

At block 604, data is electronically collected from a plurality of sources. In one embodiment, data (e.g., structured data) can be collected from databases such as, but not limited to, enterprise resource planning systems, manufacturing systems, and/or other types of compatible databases. Also, in one example, corporate standard reporting tools can be utilized to collect litigation-specific data by using business objects (e.g., sales, revenue, customer data, and manufacturer data) for case valuation and economic analysis.

In one embodiment, data (e.g., archived data stored offsite and acquired archived data) can be collected from restored tape backups (e.g., 8 mm tapes, 4 mm tapes, and DLT data cartridges). In another embodiment, data (e.g., hardcopy documents) can be collected by scanning a paper and converting it into a reviewer specified format, for example, the Portable Document Format (PDF) format. Also, in one embodiment, the reviewer specified format is a searchable format. Furthermore, in still another embodiment, data can be collected from an archive (e.g., corporate archive).

At block 606, individual custodian data is automatically gathered. The data can be automatically collected from the individual's email and/or personal documents. In one example, standard backup systems, such as but not limited to, TLM, Netstore, Robocopy, FTK, and Encase are utilized to acquire individual employee data.

At block 608, a data mining tool is utilized to automatically collect data from repositories. In one embodiment, the data mining tool can automatically collect data from document repositories (e.g., an engineering data management system, an enterprise-specific contracts repository, an enterprise specific NDA repository, and/or an enterprise specific financial documents repository.) For example, documents repositories used by the legal department, the manufacturing department, and the engineering department can be accessed by the data mining tool.

At block 610, a web crawler is utilized to automatically gather and download data from websites. In one embodiment, data (e.g., unstructured data) can be collected by the web crawler from web sources such as, but not limited to, internal and external websites (e.g., corporate websites). In another embodiment, a web crawler is utilized to walk through a web site and automatically download keyword hits for review.

At block 612, data is automatically processed using a processor. The processor is capable of processing the data in different ways. In addition to actions capable of being performed by the processor as indicated in block 614, 616, 618, 620, 622, 624, 626, and 628, in other embodiments, the processor can also be utilized to compress data, encrypt data, translate data, and/or modify data.

At block 614, an email message is converted into a unique file with its associated attachment. In one embodiment, email files are uncompressed and re-associated with its corresponding attachments. Further, the uncompressed files are stored in the working directory.

At block 616, software application files are identified. In one embodiment, the software application file is a standard system file. Identification of software application files can be implemented by an identifier tool and/or by a processor.

At block 618, software application files are compared to a database having a plurality of pre-existing files. In one embodiment, the software application files can be compared to one or more databases (e.g., National Institute of Standards and Technology database and/or Cisco database).

At block 620, a software application file is removed if the software application file matches a pre-existing file in the database. In one embodiment, identification and removal of standard software application files is implemented by utilizing a comparison tool that compares all files to a database (e.g., National Institute of Standards and Technology database and/or Cisco database.) to identify and remove standard software application files.

At block 622, duplicate files are identified. In one embodiment, identification of duplicate files is implemented by a duplicate file identification/removal tool. In one embodiment, a file is compared to a database to determine whether the file is a duplicate file.

At block 624, duplicate files are marked. A marking can be implemented in a variety of ways. For example, the associated file name can be flagged, highlighted, bolded, underlined, and or colored. In one embodiment, the marking of duplicate files occurs automatically. In another embodiment, a reviewer opinion is requested before a file is marked as a duplicate file.

At block 626, metadata associated with the data are cataloged. In one embodiment, cataloging of metadata is implemented by a processor. Metadata can include, but are not limited to, dates, file size, and file type.

At block 628, a tag is assigned to the files. In one embodiment, a unique numerical tag is assigned. In another embodiment, an alpha/numeric tag is assigned. Also, in yet another embodiment, a tag is assigned to every file collected. The addition of the tag (e.g., unique document ID) to a file may render it simpler to refer to and/or review a document.

At block 630, the processed data is transmitted to a reviewer and the reviewer reviews the processed data. In one implementation, the processed data can be transmitted over a Wide Area Network (WAN) and/or a Local Area Network (LAN). Also, it is understood that the data transmitted can be encrypted and transmitted in a secure format.

At block 632, reviewed data is received from the reviewer. In one embodiment, reviewed data includes marking by the reviewer indicating whether the data is responsive, non-responsive, privileged, or hot. In addition, in one embodiment, reviewed data includes reviewer information, such as but not limited to, reviewer activities, reviewer identities, project status, project notes.

At block 634, the reviewed data is displayed. In one embodiment, reviewed data that is marked as responsive is displayed to a reviewer, such as but not limited to, one or more attorneys.

At block 636, the process ends.

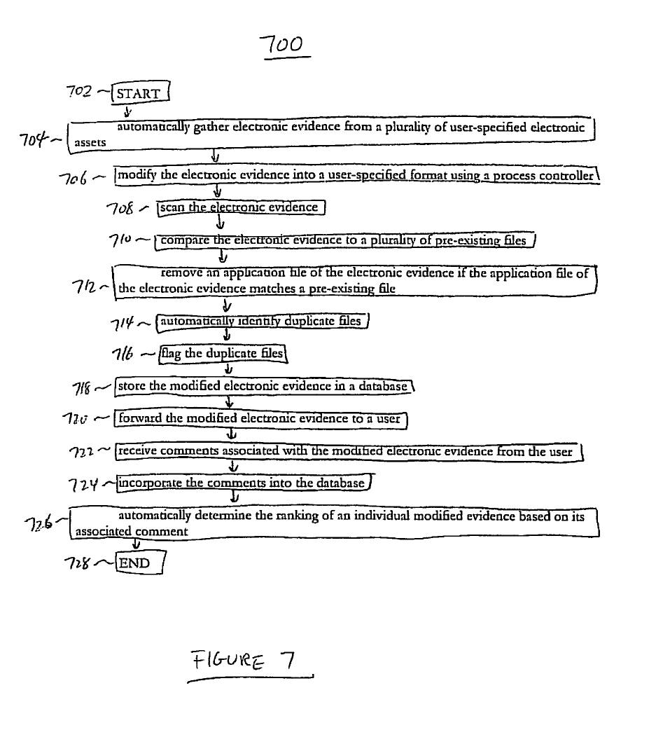

FIG. 7 illustrates a flowchart 700 of an automated evidence management system. Although specific steps are disclosed in flowchart 700, such steps are exemplary. That is, embodiments are well suited to performing various other or additional steps or variations of the steps recited in flowchart 700. It is appreciated that the steps in flowchart 700 can be performed in an order different than presented.

At block 702, the process starts.

At block 704, electronic evidence is automatically gathered from a plurality of reviewer-specified electronic assets. The plurality of reviewer-specified electronic assets can include but are not limited to structured data (e.g., databases), unstructured data (e.g., websites), archived data (e.g., tape backups), portable document format (PDF) files, tagged image file format (TIFF) files, optical character recognition (OCR) files, personal computer files (e.g., personal email messages and documents), corporate emails, and document repositories.

At block 706, the electronic evidence is modified into a reviewer-specified format using a process controller. In one embodiment, portions of files can be removed according to reviewer-specification. In another embodiment, a file can be re-formatted according to reviewer-specification.

At block 708, the electronic evidence is scanned. In one embodiment, scanning of the electronic evidence is implemented by a scanning tool. In another embodiment, the scanning of the electronic evidence is implemented by a processor.

At block 710, the electronic evidence is compared to a plurality of pre-existing files. In one embodiment, the electronic evidence is compared to one or more databases (e.g., National Institute of Standards and Technology database and/or Cisco database).

At block 712, an application file of the electronic evidence is removed if the application file of the electronic evidence matches a pre-existing file in one or more databases. Removal can be implemented in a variety of ways. In one embodiment, removal of a file is implemented by marking a file as deleted but does not involve automatically erasing the file physically from memory. In another embodiment, removal of a file is implemented by erasing the file from memory.

At block 714, duplicate files are automatically identified. In one embodiment, identification of duplicate files is implemented by a duplicate file identification/removal tool. In one embodiment, a file is compared to a database to determine whether the file is a duplicate file.

At block 716, the duplicate files are flagged. Flagging of a duplicate file can be implemented in a variety of ways. For example, the associated file name can be highlighted, bolded, underlined, and or colored. In one embodiment, the flagging of duplicate files occurs automatically. In another embodiment, a reviewer opinion is requested before a file is marked as a duplicate file.

At block 718, the modified electronic evidence is stored in a database. In one embodiment, the modified electronic evidence overwrites the pre-modified electronic evidence as to conserve memory storage. In another embodiment, the modified electronic evidence is stored in the database along with the pre-modified electronic evidence.

At block 720, the modified electronic evidence is forwarded to a reviewer. In one embodiment, the modified electronic evidence can be forwarded over a Wide Area Network (WAN) and/or a Local Area Network (LAN). Also, it is understood that the modified electronic evidence forwarded can be encrypted and transmitted in a secure format.

At block 722, comments associated with the modified electronic evidence from the reviewer are received. In one embodiment, commented modified electronic evidence includes marking by the reviewer on whether the electronic evidence is responsive, non-responsive, privileged, or hot. In addition, in one embodiment, electronic evidence includes reviewer information, such as but not limited to, reviewer activities, reviewer identities, project status, and/or project notes. Moreover, comments can also include ranking information that rates each modified electronic evidence on a reviewer-specified scale.

At block 724, the comments are incorporated into the database. In one embodiment, the modified electronic evidence may be forwarded to more than one reviewer for feedback. By incorporating the comments into the database, one reviewer can review comments contributed by another reviewer.

At block 726, the ranking of an individual modified evidence based on its associated comment is automatically determined. In one embodiment, a ranking tool is utilized to automatically calculate a ranking of an individual modified electronic evidence based on its associated reviewer comments.

At block 728, the process ends.

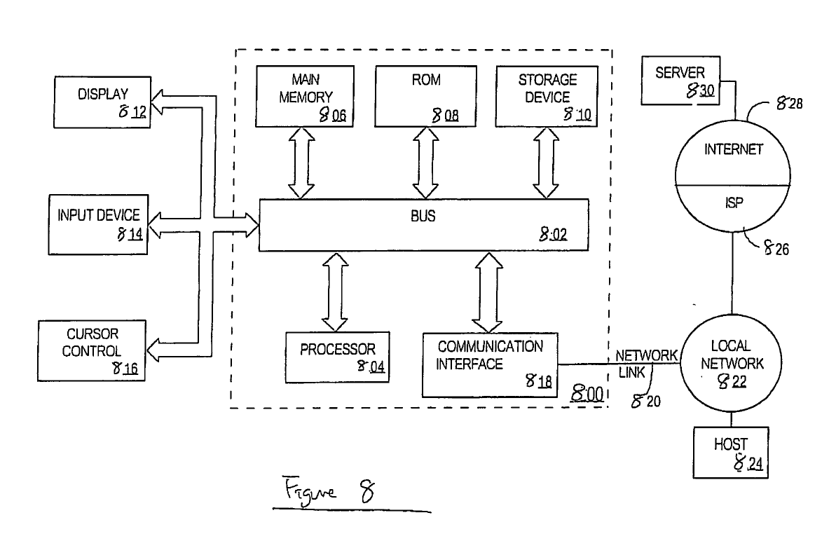

FIG. 8 is a block diagram that illustrates a computer system 800 upon which embodiments of the may be implemented. Computer system 800 includes a bus 802 or other communication mechanism for communicating information, and a processor 804 coupled with bus 802 for processing information litigation related information). Computer system 800 also includes a main memory 806, such as a random access memory (RAM) or other dynamic storage device, coupled to bus 802 for storing information and instructions (e.g., instructions for comparing files to a National Institute of Standards and Technology database) to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to an optional display 812 for displaying information to a reviewer. An input device 814, including alphanumeric and other keys, may be coupled to bus 802 for communicating information and command selections to processor 804. Another type of reviewer input device may include a cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to utilizing computer system 800 for an automated litigation discovery system. According to one embodiment of the invention, the utilization of the automated litigation discovery system is provided by computer system 800 in response to processor 804 executing one or more sequences of one or more instructions contained in main memory 806. Such instructions may be read into main memory 806 from another computer readable medium, such as storage device 810. Execution of the sequences of instructions contained in main memory 806 causes processor 804 to perform the process steps (e.g., identify and remove standard system files) described herein. One or more processors in a multi-processing arrangement may also be employed to execute the sequences of instructions contained in memory 806. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data (e.g., individual custodian data) on the telephone line and use an infrared transmitter to convert the data to an infrared signal. An infrared detector coupled to bus 802 can receive the data carried in the infrared signal and place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 may also include a communication interface 818 coupled to bus 802. Communication interface 818 may provide a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices and reviewers. For example, network link 820 may provide a connection through local network 822 to a host computer 824 or to data equipment operated by an Internet Service Provider (ISP) 826. ISP 826 in turn provides data communication services through the worldwide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of carrier waves transporting the information.

Computer system 800 can send and receive data (e.g., corporate emails), including program code, through the network(s), network link 820 and communication interface 818. In the Internet example, a server 830 might transmit a requested code for an application program through Internet 828, ISP 826, local network 822 and communication interface 818. The received code may be executed by processor 804 as it is received, and/or stored in storage device 810, or other non-volatile storage for later execution. In this manner, computer system 800 may obtain application code in the form of a carrier wave.

To summarize, embodiments allow litigation discovery processes to proceed more effectively. In one example, by utilizing an automated litigation discovery system that automatically gathers evidence, fewer data gatherers are needed. Also, in one example, because embodiments can gather individual custodian data automatically, there is less negative intrusion into corporate employees' work schedule. Moreover, in one example, embodiments automatically remove unnecessary files and mark duplicate files, which further reduces processing and review time.

In the foregoing specification, embodiments of the invention have been described with reference to numerous specific details that can vary from implementation to implementation. Thus, the sole and exclusive indicator of what is, and is intended by the applicants to be the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. An automated litigation discovery method, said method comprising:
electronically collecting data having a plurality of files from a plurality of sources;
automatically processing said data using a processor, wherein said processor performs:
identifying software application files;
comparing said software application files to a database having a plurality of pre-existing files;
removing a software application file if said software application file matches a pre-existing file in said database;
identifying duplicate files; and
marking said duplicate files; and
transmitting said processed data to a reviewer, wherein said reviewer reviews said processed data.

2. The method of claim 1, wherein said collecting further comprises automatically gathering individual custodian data.

3. The method of claim 1, wherein said collecting further comprises utilizing a data mining tool to automatically gather data from repositories.

4. The method of claim 1, wherein said collecting further comprises utilizing a web crawler to automatically gather and download data from websites.

5. The method of claim 1, wherein said processing further comprises assigning a unique numerical tag to said files.

6. The method of claim 1, wherein said processing further comprises cataloging metadata associated with said data.

7. The method of claim 1, wherein said processing further comprises converting an email message into a unique file with its associated attachment.

8. The method of claim 1, wherein said plurality of sources is selected from the group consisting of: databases, websites, tape backups, hardcopy documents, individual custodian data, email messages, and document repositories.

9. The method of claim 1, wherein said reviewed data is marked as responsive, non-responsive, privileged, or hot.

10. The method of claim 1, wherein said reviewed data includes reviewer identity, project status, and project notes.

11. An automated litigation discovery system, said system comprising:
a collector for electronically collecting data having a plurality of files from a plurality of sources;
a processor which automatically processes said data to identify software application files and duplicate files, wherein said software application files are compared to a database having a plurality of pre-existing files, wherein a software application file is removed if said software application file matches a pre-existing file in said database, and wherein said duplicate files are marked; and
a transmitter for transmitting said processed data to a reviewer, wherein said reviewer reviews said processed data.

12. The system of claim 11, wherein said collector utilizes reporting tools to extract data.

13. An automated evidence management method, said method comprising:
automatically gathering electronic evidence from a plurality of reviewer-specified electronic assets;
modifying said electronic evidence into a reviewer-specified format using a process controller;
storing said modified electronic evidence in a database;
forwarding said modified electronic evidence to a reviewer;
receiving comments associated with said modified electronic evidence from said reviewer; and
incorporating said comments into said database.

14. The automated evidence management method of claim 13, wherein said modifying further comprises:
scanning said electronic evidence;
comparing said electronic evidence to a plurality of pre-existing files; and
removing an application file of said electronic evidence if said application file matches a pre-existing file.

15. The automated evidence management method of claim 13, wherein said modifying further comprises:
automatically identifying duplicate files; and
flagging said duplicate files.

16. The automated evidence management method of claim 13, wherein said receiving comments comprises receiving comments from an online interface accessible by said reviewer.

17. The automated evidence management method of claim 13 further comprises automatically determining the ranking of an individual modified evidence based on its associated comment.

18. A computer readable medium having stored therein instructions that when executed by a processor implements an automated litigation discovery method, said method comprising:
electronically collecting data having a plurality of files from a plurality of sources;
automatically processing said data, said processing comprising:
identifying software application files;
comparing said software application files to a database having a plurality of pre-existing files;
removing a software application file if said software application file matches a pre-existing file in said database;
identifying duplicate files;
marking said duplicate files; and
transmitting said processed data to a reviewer, wherein said reviewer reviews said processed data.
